(19) United States
(12) Patent Application Publication
(10) Pub. No.: US 2016/0187613 A1
(43) Pub. Date: Jun. 30, 2016

(54) CAMERA MODULE

(71) Applicant: Samsung Electro-Mechanics Co., Ltd., Suwon-si (KR)

(72) Inventors: Sang Hyo SEO, Suwon-si (KR); Kyung Hun LEE, Suwon-si (KR); Dong Woo LEE, Suwon-si (KR)

(73) Assignee: SAMSUNG ELECTRO-MECHANICS CO., LTD., Suwon-si (KR)

(21) Appl. No.: 14/927,754

(22) Filed: Oct. 30, 2015

(30) Foreign Application Priority Data
Dec. 31, 2014 (KR) 10-2014-0194773

(51) Int. Cl. G02B 7/08; G02B 3/14; G02B 13/00; G02B 7/02

(52) U.S. Cl. CPC G02B 7/08; G02B 7/021; G02B 3/14; G02B 13/001

(57) ABSTRACT

A camera module includes: a housing having a connection electrode; a fixed lens disposed in the housing and arranged on an optical axis; an actuator mounted in the housing and connected to the connection electrode; and a movable lens coupled to the actuator and configured to be moved by the actuator, the movable lens being disposed on the optical axis.

### CROSS-REFERENCE TO RELATED APPLICATION(S)

This application claims the benefit of Korean Patent Application No. 10-2014-0194773 filed on Dec. 31, 2014, in the Korean Intellectual Property Office, the entire disclosure of which is incorporated herein by reference for all purposes.

### BACKGROUND

1. Field

The following description relates to a camera module in which an actuator is easily miniaturized.

2. Description of Related Art

A camera module is an apparatus for converting image information into electrical signals. Such an apparatus may be mounted in a portable terminal to perform additional functions of the portable terminal. For example, a small camera module is mounted in a mobile phone to enable video telephony. An example of a camera module is disclosed in Korean Patent No. 2013-0030062 A.

Portable terminals have been slimmed in order to be easily carried and stored. Accordingly, camera modules mounted in portable terminals have also been miniaturized and slimmed. Further, as performance of portable terminals has improved, demand for a camera module having high resolution and high performance has increased.

Therefore, the development of a small camera module capable of performing an auto-focusing function while implementing high-resolution images is required.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one general aspect, a camera module includes: a housing including a connection electrode; a fixed lens disposed in the housing and arranged on an optical axis; an actuator mounted in the housing and connected to the connection electrode; and a movable lens coupled to the actuator and configured to be moved by the actuator, the movable lens being disposed on the optical axis.

The actuator may include a groove, and the movable lens may include a protrusion inserted in the groove.

The actuator may include an inclined surface, the movable lens may include an inclined surface not parallel to the inclined surface of the actuator, and the inclined surface of the actuator and the inclined surface of the movable lens may contact each other.

The actuator may include: a supporting member including a contact electrode connected to the connection electrode; a base member on which the movable lens is mounted; a connecting member connecting the base member and the supporting member; and a piezoelectric element disposed on the connecting member and configured to deform the connecting member in response to electrical signals.

The connection electrode may be disposed on an outer surface of the housing.

The connection electrode may be disposed on an inner surface of the housing.

The camera module may further include a lens barrel accommodating the fixed lens.

The camera module may further include a sensor disposed in the housing and configured to sense a position of the movable lens.

According to another general aspect, a camera module includes: a housing including a connection electrode; a fixed lens disposed in the housing and arranged on an optical axis; and a variable lens unit mounted in the housing on the optical axis and coupled to the housing, the variable lens unit having a refractive power configured to be changed in response to electrical signals.

The variable lens unit may include: transparent substrates including a fluid accommodating space therebetween; and a fluid disposed in the fluid accommodating space and having a shape configured to be changed in response to the electrical signals.

The housing may include a groove, and the variable lens unit may include a protrusion coupled to the groove.

The camera module may further include a conductive adhesive disposed between the housing and the variable lens unit.

According to another general aspect, a camera module includes: a fixed lens disposed in the housing; an actuator mounted in the housing and connected to the connection electrode, the actuator including a connecting member connected to the movable lens, and a piezoelectric element disposed on the connecting member and configured to deform the connecting member in response to electrical signals; and a movable lens coupled to the actuator and configured to be moved by the deforming of the connecting member.

The movable lens may be configured to be moved in a direction of an optical axis of the movable lens by the deforming of the connecting member.

The movable lens may be configured to be moved in a direction oblique to an optical axis of the movable lens by the deforming of the connecting member.

Other features and aspects will be apparent from the following detailed description, the drawings, and the claims.

### BRIEF DESCRIPTION OF THE DRAWINGS

FIG. 1 is an exploded perspective view of a camera module according to an example.

FIG. 2 is a plan view of an actuator illustrated in FIG. 1, according to an example.

FIG. 3 is an assembled perspective view of the camera module illustrated in FIG. 1.

FIG. 4 is a cross-sectional view of the camera module taken along line A-A of FIG. 3.

FIG. 5 is a cross-sectional view illustrating an assembled relationship of an actuator and a movable lens of the camera module illustrated in FIG. 3, according to an example.

FIG. 6 is an exploded perspective view of a camera module according to another example.

FIG. 7 is a cross-sectional view of a variable lens unit illustrated in FIG. 6, according to an example.

FIG. 8 is an assembled perspective view of the camera module illustrated in FIG. 7.

FIG. 9 is a cross-sectional view of the camera module taken along line B-B of FIG. 8.

FIG. 10 is an enlarged view of part C illustrated in FIG. 9.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

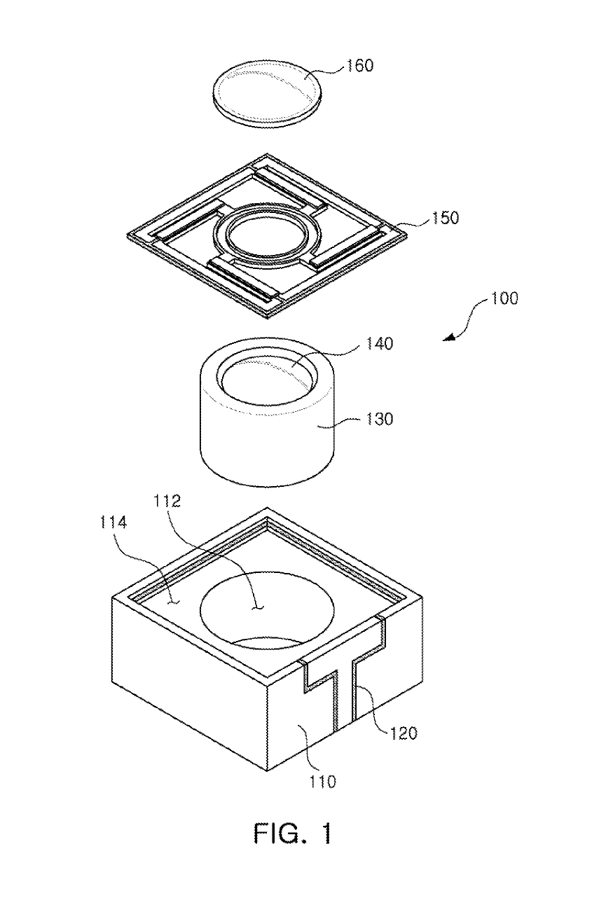

A separated form of a camera module 100 according to an example will be described with reference to FIG. 1.

The camera module 100 accommodates a plurality of lenses. For example, the camera module 100 includes a housing 110 accommodating a fixed lens 140 (FIG. 4) and a movable lens 160 (FIG. 4). An accommodating part 112 in which a lens barrel 130 including the fixed lens 140 is mounted is formed in the housing 110, and a mounting part 114 on which the movable lens 160 is mounted is formed at an upper portion of the housing 110.

An electrical connection may easily be made in the camera module 100. For example, the camera module 100 includes a connection electrode 120 formed on the housing 110.

The connection electrode 120 may be formed by a molded interconnect device (MID). For example, the connection electrode 120 may be formed on the housing 110 by a technology such as a laser direct structure (LDS), microscopic integrated processing technology (MIPTEC), or the like. Here, the LDS technology may be advantageous in forming the connection electrode 120 to have a large area on the housing 110, and the MIPTEC technology may be advantageous in forming the connection electrode 120 to have a small size on the housing 110.

The connection electrode 120 may be formed on a surface of the housing 110. For example, the connection electrode 120 may be formed on an outer surface of the housing 110. As another example, the connection electrode 120 may be formed on an inner surface of the housing 110. As another example, the connection electrode 120 may be formed on both the outer and inner surfaces of the housing 110.

Since the camera module 100 having the above-mentioned form has the connection electrode 120 formed integrally on the surface of the housing 110, an electrical connection between an actuator 150 and a portable terminal may be easily made. Further, since a flexible substrate is not provided in the camera module 100 for making the electrical connection, a process of manufacturing the camera module may be easily automated.

The camera module 100 performs at least one of an auto-focusing function and a shake correction function. For example, the actuator 150 is configured to move one or more lenses in an optical axis direction.

The actuator 150 is connected to the connection electrode 120. For example, the actuator 150 is electrically connected to the connection electrode 120 so as to be operated according to electrical signals transferred through the connection electrode 120.

The camera module 100 enables the actuator 150 to have a slim construction and reduced current consumption. To this end, the camera module 100 includes a lens which is moved by the actuator 150 and a lens which is not moved by the actuator 150. For example, the fixed lens 140 is not moved by the actuator 150 and has a relative position with respect to the housing 110 that is permanently fixed, and the movable lens 160 is moved by the actuator 150 and has a relative position with respect to the housing 110 that varies.

The fixed lens 140 is firmly fixed to the housing 110. For example, a relative position of the fixed lens 140 with respect to the housing 110 is fixed as the lens barrel 130 and the housing 110 are firmly coupled to each other.

The movable lens 160 is movable in the optical axis direction (the direction of the optical axis Y in FIG. 4) by the actuator 150. Thus, a focal length of the camera module 100 may be freely adjusted depending on the position of the movable lens 160.

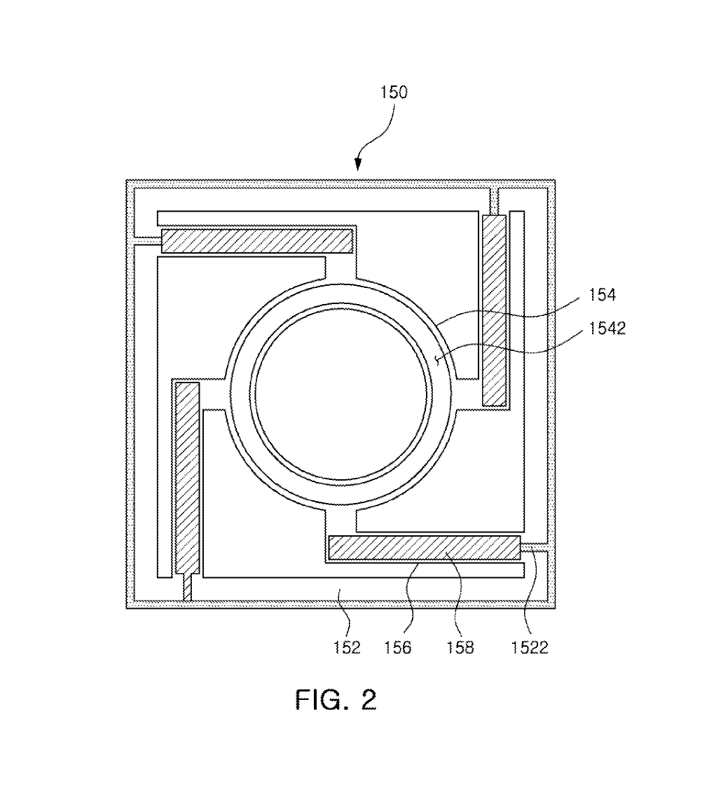

Next, the actuator 150 and movement of the movable lens 160 will be described with reference to FIG. 2.

The actuator 150 is operable to change a relative position of the movable lens 160 with respect to the fixed lens 140. For example, the actuator 150 is operable to move the movable lens 160 in the optical axis direction. For example, the actuator 150 adjusts the focal length of the camera module 100 by moving the movable lens 160 in a direction towards the fixed lens 140 or in a direction away from the fixed lens 140. As another example, the actuator 150 moves the movable lens 160 in a direction oblique to the optical axis. For example, in a case in which an optical axis Y of the movable lens 160 does not coincide with an optical axis of the fixed lens 140, the actuator 150 obliquely moves the movable lens 160 so that the optical axes of the lenses 160 and 140 coincide with each other.

The actuator 150 may be easily miniaturized. For example, the actuator 150 is generally formed in a plate shape. The actuator 150 may be manufactured, for example, in a semiconductor wafer process.

The actuator 150 includes a supporting member 152, a base member 154, a connecting member 156, and a piezoelectric element 158.

The supporting member 152 is advantageously mounted in the housing 110. For example, the supporting member 152 has a thin plate shape and is electrically connected to the connection electrode 120. For example, a contact electrode 1522 is formed on the supporting member 152. The contact electrode 1522 may be formed along an edge of the supporting member 152 and electrically connects the connection electrode 120 and the piezoelectric element 158 to each other.

The base member 154 stably supports the movable lens 160. For example, the base member 154 may have a ring shape having substantially the same size as that of a flange part of the movable lens 160. The base member 154 aligns a position of the movable lens 160. For example, a groove 1542 which is coupled to a portion of the movable lens 160 is formed in the base member 154.

The connecting member 156 connects the supporting member 152 and the base member 154 to each other. For example, the connecting member 156 may extend linearly from the supporting member 152 towards the base member 154. The connecting member 156 is deformable to be bent. For example, the connecting member 156 may be upwardly bent or downwardly bent by a predetermined magnitude of force applied thereto.

The piezoelectric element 158 is operable to deform the connecting member 156. For example, the piezoelectric element 158 may be formed on the connecting member 156 to upwardly or downwardly bend the connecting member 156. The piezoelectric element 158 is operated according to electrical signals. For example, the piezoelectric element 158 is connected to the connection electrode 120 by the contact electrode 1522, and receives the electrical signals through the connection electrode 120 to bend the connecting member 156, and thereby move the movable lens 160 along with the base member 154.

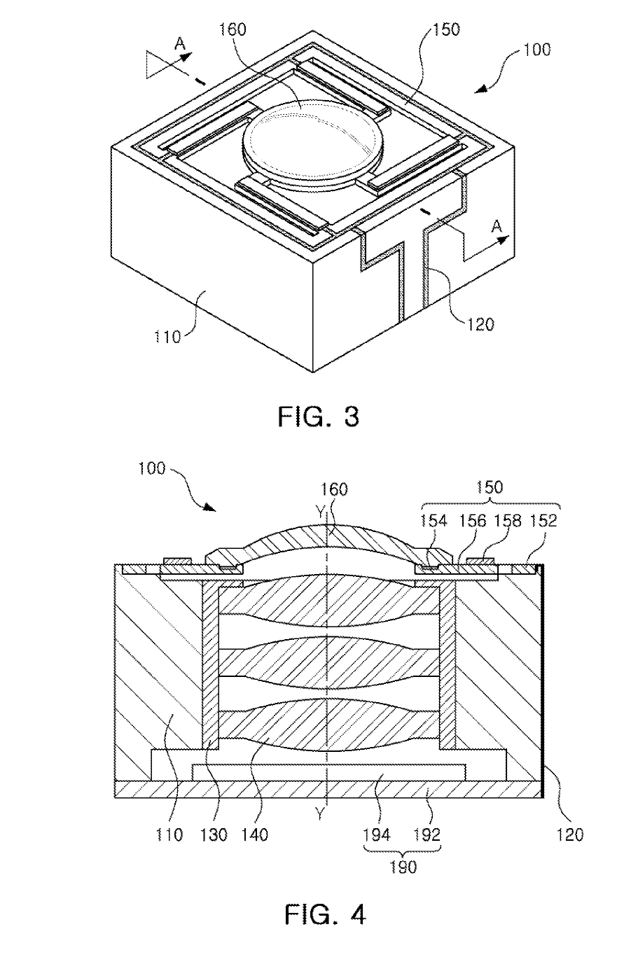

An assembled form of the camera module 100 will be described with reference to FIG. 3.

The camera module 100 may be formed in a form of a single part as illustrated in FIG. 3. Therefore, the camera module 100 may be easily mounted in a small portable terminal.

The camera module 100 may be easily connected to a portable terminal. For example, the camera module 100 may be connected to a control unit of the portable terminal through the connection electrode 120, which is formed on the surface of the housing 110. Therefore, the camera module 100 is substantially free from spatial constraints of the portable terminal.

A cross-section form of the camera module 100 will be described with reference to FIG. 4.

The camera module 100 may have a structure in which the fixed lens 140 and the movable lens 160 are aligned with each other in the optical axis direction. For example, the optical axis of the fixed lens 140 may coincide with the optical axis Y of the movable lens 160.

The camera module 100 includes an image sensor unit 190. For example, the image sensor unit 190 is mounted on a lower portion of the housing 110. The image sensor unit 190 is configured to convert image information incident through the lenses 140 and 160 into electrical signals. For example, the image sensor unit 190 includes an image sensor 194. The image sensor unit 190 is configured to control the position of the movable lens 160. For example, the image sensor unit 190 includes a substrate 192 configured to transmit the electrical signals to the actuator 150.

The movable lens 160 may be moved in the optical axis direction and other directions as described above. For example, the movable lens 160 may be moved to a position further from the fixed lens 140, or to a position closer to the fixed lens 140 by the actuator 150.

The actuator 150 is connected to the image sensor unit 190 as described above. For example, the actuator 150 is connected to the substrate 192 of the image sensor unit 190 by the connection electrode 120. As described above, the actuator 150 is operable to move the movable lens 160 according to the electrical signals transmitted by the image sensor unit 190.

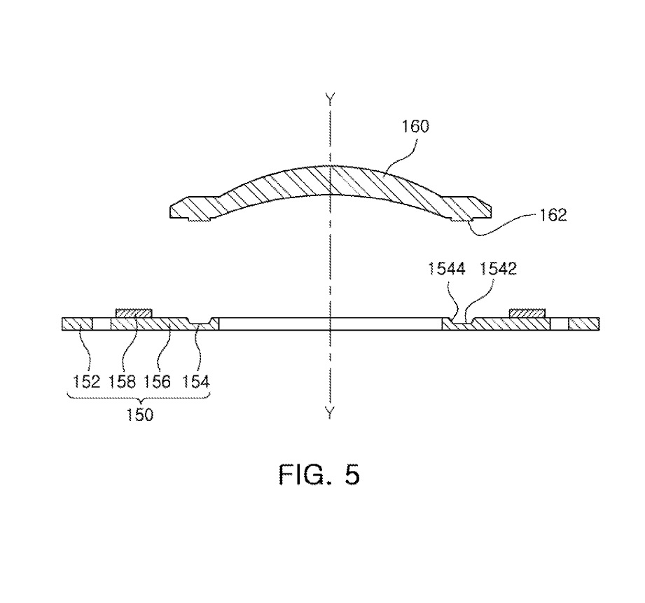

An optical axis alignment structure of the actuator 150 and the movable lens 160 will be described with reference to FIG. 5.

In the camera module 100, the optical axis Y of the movable lens 160 is aligned by a coupling of the actuator 150 and the movable lens 160. For example, the optical axis Y of the movable lens 160 is naturally aligned as a protrusion 162 of the movable lens 160 is inserted into the groove 1542 of the actuator 150.

A side surface 1544 of the groove 1542 formed in the actuator 150 may have a tilted angle. The protrusion 162 of the movable lens 160 may have a cross-section having a form different from that of the side surface 1544. For example, the groove 1542 of the actuator 150 and the protrusion 162 of the movable lens 160 may be in line contact with each other.

Since the above-mentioned coupled form of the actuator 150 and the movable lens 160 easily align the position of the movable lens 160 according to the actuator 150, the optical axis of the movable lens 160 and the optical axis of the fixed lens 140 are easily made to coincide with each other.

Hereinafter, a camera module 200 according to another example will be described. For reference, in the following description, the same components as those described above will be denoted by the same reference numerals, and a detailed description thereof will be omitted.

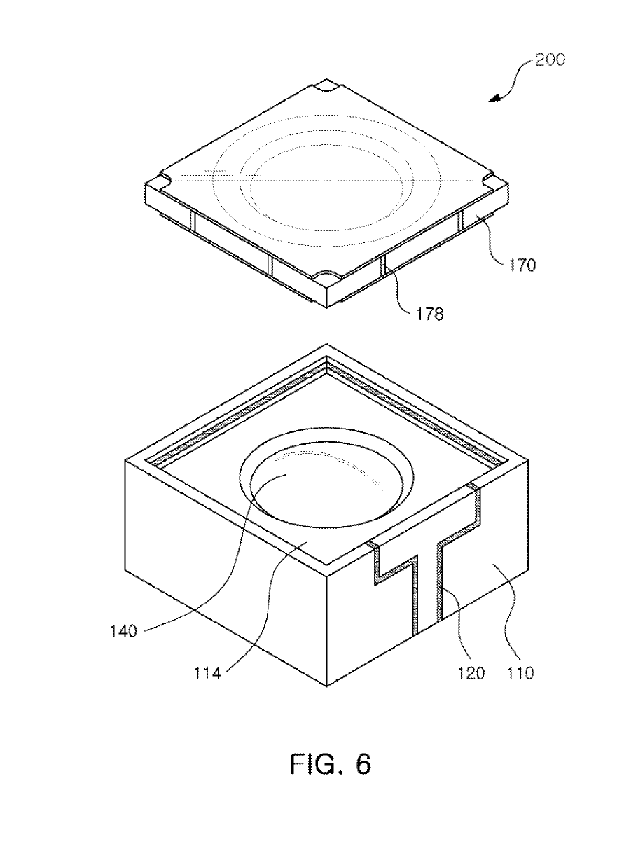

Main configurations of the camera module 200 according to another example will be described with reference to FIG. 6.

The camera module 200 differs from the camera module 100 described above based on a different arrangement of the connection electrode 120 in the camera module 200. For example, in the camera module 200, the connection electrode 120 is formed on an inner surface of the housing 110.

The camera module 200 further differs from the camera module 100 based on the manner in which the fixed lens 140 is coupled to the housing 110 in the camera module 200. For example, the fixed lens 140 is directly mounted to the housing 110 in the camera module 200.

The camera module 200 further differs from the camera module 100 based on a different configuration of the camera module 200 for performing a focusing function. For example, the focusing function is performed in the camera module 200 by a variable lens unit 170.

The variable lens unit 170 includes a contact electrode 178. The contact electrode 178 is connected to the connection electrode 120.

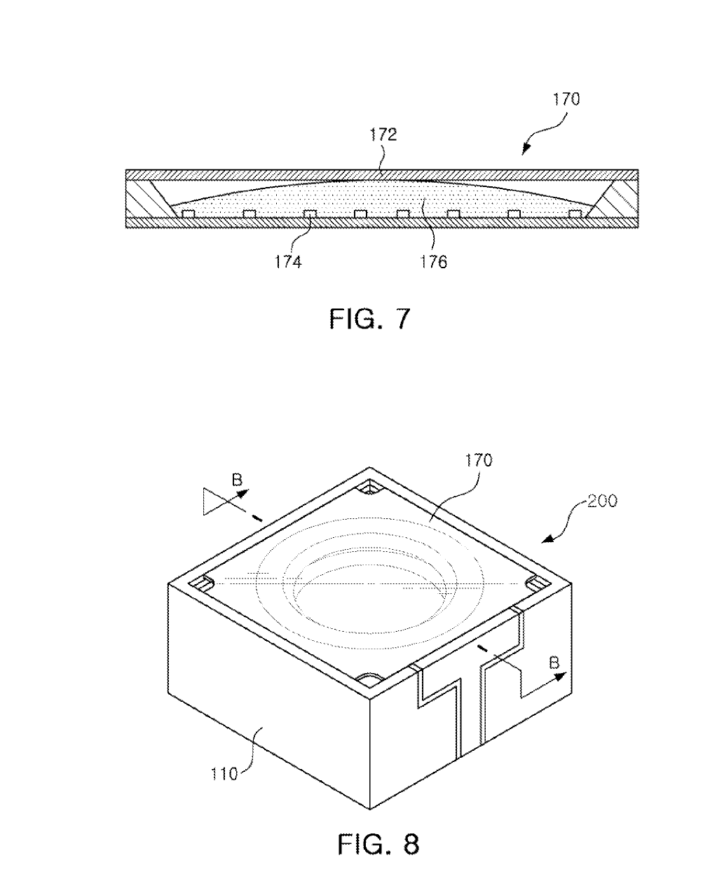

An example structure of the variable lens unit 170 will be described with reference to FIG. 7.

The variable lens unit 170 is a lens in which refractive power is changed. For example, the variable lens unit 170 is a fluid lens of which a shape is changed according to the electrical signals.

The variable lens unit 170 includes transparent substrates 172, electrodes 174, and a fluid 176. A plurality of transparent substrates 172 are spaced apart from each other by a predetermined distance to form a fluid accommodating space in which the fluid 176 is accommodated. The electrodes 174 may be formed on one surface of the transparent substrate 172 and generate various magnitudes of an electric field or a magnetic field depending on the electrical signals. The fluid 176 functions as the lens having refractive power, and a shape of the fluid 176 is changed according to the magnitudes of the electric field or the magnetic field generated by the electrodes 174.

The camera module 200 is configured to change the shape of the fluid 176 to adjust the focal length.

An assembled form of the camera module 200 will be described with reference to FIG. 8.

The camera module 200 may have a slim construction, similar to the camera module 100. Further, in the camera module 200, the focal length may be finely adjusted by the variable lens unit 170.

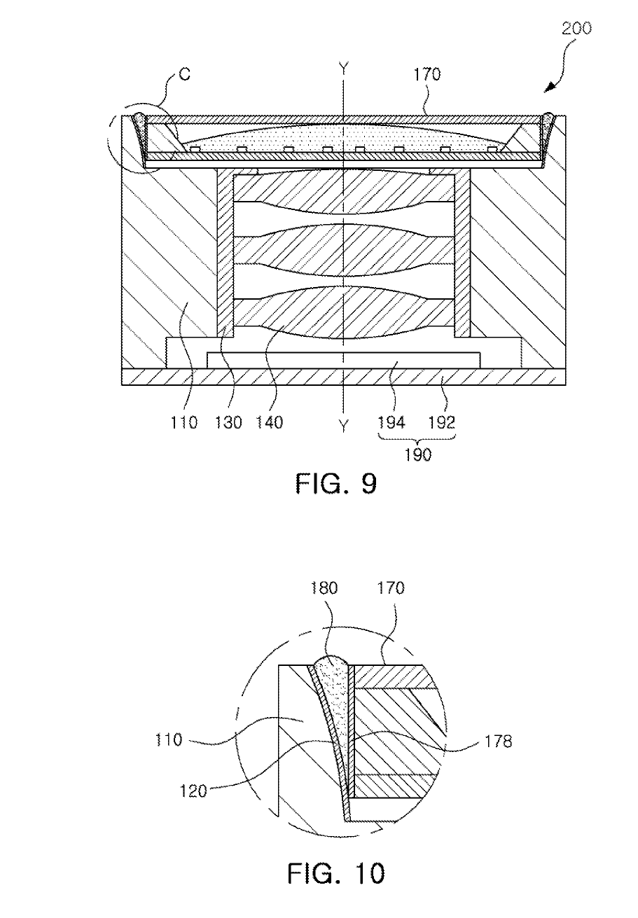

A cross-section form of a camera module 200 will be described with reference to FIGS. 9 and 10.

The camera module 200 may be configured so that optical axes of the fixed lens 140 and the variable lens unit 170 are aligned. For example, the housing 110 and the variable lens unit 170 may be in line contact with each other. For example, the connection electrode 120 of the housing 110 may be formed in a curved shape to always be in line contact with a side surface of the variable lens unit 170.

As such, since the housing 110 and the variable lens unit 170 are coupled to each other as described above, the variable lens unit 170 may easily be aligned with respect to the housing 110. After the variable lens unit 170 is aligned, an adhesive 180 may be injected between the housing 110 and the variable lens unit 170 to firmly fix the position of the variable lens unit 170. The adhesive 180 may include a conductive material. For example, the adhesive 180 may include the conductive material in order to smoothly provide an electrical connection between the connection electrode 120 and the electrodes 178 of the variable lens unit 170.

According to the examples described herein, a small camera module having an auto-focusing function and a shake correction function may be provided.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a housing comprising a connection electrode;
a fixed lens disposed in the housing and arranged on an optical axis;
an actuator mounted in the housing and connected to the connection electrode; and
a movable lens coupled to the actuator and configured to be moved by the actuator, the movable lens being disposed on the optical axis.

2. The camera module of claim 1, wherein:
the actuator comprises a groove; and
the movable lens comprises a protrusion inserted in the groove.

3. The camera module of claim 1, wherein:
the actuator comprises an inclined surface;
the movable lens comprises an inclined surface not parallel to the inclined surface of the actuator; and
the inclined surface of the actuator and the inclined surface of the movable lens contact each other.

4. The camera module of claim 1, wherein the actuator comprises:
a supporting member comprising a contact electrode connected to the connection electrode;
a base member on which the movable lens is mounted;
a connecting member connecting the base member and the supporting member; and
a piezoelectric element disposed on the connecting member and configured to deform the connecting member in response to electrical signals.

5. The camera module of claim 1, wherein the connection electrode is disposed on an outer surface of the housing.

6. The camera module of claim 1, wherein the connection electrode is disposed on an inner surface of the housing.

7. The camera module of claim 1, further comprising a lens barrel accommodating the fixed lens.

8. The camera module of claim 1, further comprising a sensor disposed in the housing and configured to sense a position of the movable lens.

9. A camera module comprising:
a housing comprising a connection electrode;
a fixed lens disposed in the housing and arranged on an optical axis; and
a variable lens unit mounted in the housing on the optical axis and coupled to the housing, the variable lens unit having a refractive power configured to be changed in response to electrical signals.

10. The camera module of claim 9, wherein the variable lens unit comprises:
transparent substrates comprising a fluid accommodating space therebetween; and
a fluid disposed in the fluid accommodating space and having a shape configured to be changed in response to the electrical signals.

11. The camera module of claim 9, wherein:
the housing comprises a groove;
the variable lens unit comprises a protrusion coupled to the groove.

12. The camera module of claim 9, further comprising a conductive adhesive disposed between the housing and the variable lens unit.

13. A camera module, comprising:
a housing comprising a connection electrode;
a fixed lens disposed in the housing;
an actuator mounted in the housing and connected to the connection electrode, the actuator comprising
a connecting member connected to the movable lens, and
a piezoelectric element disposed on the connecting member and configured to deform the connecting member in response to electrical signals; and
a movable lens coupled to the actuator and configured to be moved by the deforming of the connecting member.

14. The camera module of claim 13, wherein the movable lens is configured to be moved in a direction of an optical axis of the movable lens by the deforming of the connecting member.

15. The camera module of claim 13, wherein the movable lens is configured to be moved in a direction oblique to an optical axis of the movable lens by the deforming of the connecting member.
